(19) United States
(12) Patent Application Publication
(10) Pub. No.: US 2011/0066499 A1
(43) Pub. Date: Mar. 17, 2011

(54) METHOD FOR TRANSMITTING MEASURED ADVERTISING AND/OR INFORMATION AND A SYSTEM FOR CARRYING OUT SAID METHOD

(76) Inventor: Bunyak Jury Anatolievich, Vinnitsa (UA)

(21) Appl. No.: 12/742,256

(22) PCT Filed: Sep. 12, 2008
(86) PCT No.: PCT/RU2008/000595

§ 371 Date: May 11, 2010

(30) Foreign Application Priority Data
May 29, 2008 (RU) 2008121575

(51) Int. Cl. G06Q 30/00

(52) U.S. Cl. 705/14.56; 705/14.55

(57) ABSTRACT

A system of target advertising delivery by communications operators or Internet providers is provided. The system contains subscriber terminals connected to ISP switching equipment, a first input/output of which connects to a first input/output of an Internet resources access server and a second input/output of which connects to Internet resources. The second ISP input/output connects to a first input/output of an advertising management module for detecting an information package from the subscriber. A first monitoring input of the advertising management module connects to the first ISP input/output. Second and third input/outputs of the advertising management module connect to a statistics server and advertising content server. A fourth input/output of the advertising management module connects to an operator's management terminal, and a second monitoring input of the advertising management module connects to the third ISP input/output connected, in turn, to the input/output of the confirmation server for performing data exchange operations.

### BACKGROUND OF THE INVENTION

1. Field of the Invention

The invention is related to the advertising business and is designed for target advertising of goods and services, taking into account the supposed consumer preferences of subscribers, and other information.

2. Description of the Related Art

High competition on the telecommunications and communications market compels mobile digital communications operators, fixed-line (including wireless) communications operators, Internet service providers, and broadband access providers (hereinafter—operators) to search for ways of lowering the tariffs of the provided services, provide new services, attract new consumers, and find new income sources. One of such ways is additional income received by operators for publishing advertising at advertisers' expense. However, advertisers are interested in efficient and effective advertising. As operators have direct contact with subscribers, they receive information about subscribers in the process of service provision, e.g. address, personal data, visited websites. This information can be used to identify the probable consumer preferences and design advertising campaigns in order to deliver target advertising to target groups of subscribers. Such approach is mutually beneficial for all parties to the process, above all the subscribers, as it leads to the lowering of the cost of services and helps make advertising which is unavoidable in the present-day conditions potentially useful.

Advertising is performed by delivering the advertising content to subscribers of the operator's local data transmission network, formed and managed by the operator's technical means.

The implementation of target advertising requires technical means, such as local network and databases access means and relevant software. The required technical means largely depend on the task implementation method.

One of the known target advertising systems (U.S. Pat. No. 6,339,761. Internet service provider advertising system. Jan. 15, 2002) in the Internet Service Provider (ISP) network contains a multitude of subscriber terminals connected to the local network and by ISP technical means to the Internet; the subscribers' databases and target advertising content servers are also connected to the local network. The system enables to modify the content of the web-pages requested by subscribers in such a way to make it possible to transmit the target advertising content instead of the initial advertising content. This is being done with the help of a special programme selecting the most suitable operating systems from the advertising content database on the basis of a number of criteria. The programme is installed on the network provider's equipment.

The system's disadvantages include the fact that a provider (operator) can substitute the content of a web-page only on the basis of a contract with the page owner. This entails additional outlays which may not be compensated if the advertising is not successful, and also restricts the number of websites, as it is difficult to conclude contracts even with the owners of the top one hundred most popular sites.

Another method and system of target advertising (U.S. Pat. No. 6,513,052. Targeted advertising over global computer networks. Jan. 28, 2003) is based on using for the advertising content insertion the time intervals in the operation of a subscriber's computer pending the receipt of data requested from remote resources during Internet access. In order not to disrupt the operation of the computer, its profile is read by the system server to use the computer parameters as a criterion for choosing the advertising content. Upon the completion of the advertising content transmission, the system server restores the profile of the computer.

The drawbacks of the method and its implementing system include the fact that the method implementation requires the installation of substandard computer software on subscribers' equipment supporting access to the computer profile—the parameters of the implemented programmes, i.e. the core of the operating system (OS). Considering that the number of operating systems and their versions is quite large (not less than ten), it is rather difficult to implement such software and adapt it to every operating system. At the same time, far from all subscribers will agree to provide third party access to their computer profiles for security considerations, especially if subscribers are offices of companies or state institutions.

One more target advertising method and system (U.S. Pat. No. 6,332,127. Systems, methods and computer program products for providing time and location specific advertising via the interne. Dec. 18, 2001) is based on modifying the content of web-pages requested by an Internet subscriber by inserting the advertising content with account taken of the subscriber's location, date and time. The subscriber's location is identified with the help of a GSP navigation system and a special electronic coupon installed on his mobile computer. The coupon and its coordinates are registered by the target advertising system server which uses these data as well as other criteria to select the most appropriate advertising to be inserted in the web-page.

The disadvantage of this method and system consists in the fact that they can be implemented only with the use of auxiliary equipment which has to be purchased by the subscriber or installed by the provider at its own expense. Considering that the provision of advertising by an operator and its receipt by a subscriber is not a principal functional element of Internet service provision, neither of the parties is interested in additional expenses.

Another method of target advertising (U.S. Pat. No. 6,516,311. Method for linking on the internet with an advertising feature. Feb. 4, 2003) is based on associating websites of the companies providing certain services or products with their telephone numbers. To look through a company's website, the subscriber should enter its telephone number in the browser, and together with the requested page he will be able to see the advertising related to the services or products requested by him. The most suitable advertising is selected on the basis of the telephone number associated with a particular type of services of products.

The disadvantage of this method is the need for a special (substandard) web browser provided with a database of telephone numbers. Such telephone number databases are currently available only for wire communications, the sector of which is constantly decreasing.

One more target advertising method (U.S. Pat. No. 5,996,007. Method for providing selected content during waiting time of an Internet session. Nov. 30, 1999) is based on transmission of the target advertising content to subscribers during the intervals in subscribers' access sessions to centralised Internet resources. The content transmission is initiated by a special programme installed on the subscribers' computers. The programme analyses the information requested by a subscriber—the URL (Uniform Resource Location) reference address, as well as the profile-based computer status. If a URL access session is detected and the computer (communication channel) is in a pending mode, the programme initiates a request to the provider's server for advertising content transmission. The content selection criteria include the subscriber's profile, which can be preset at his own discretion, access frequency, and subjects of Internet resources.

The disadvantage of the method is the need for special substandard Internet access software for its implementation. Moreover, this software has to work at the level of the operating system core as it analyses the computer status (its profile). Such software may occupy a considerable resource of the subscriber's computer, and its implementation is complicated due to a large number of operating system producers and versions. In addition, this software should either be purchased by the subscriber or installed by the provider during the subscriber's connection to the network. In any of these cases, this will entail additional expenses for a function which is not necessary.

There is a target advertising method and system (U.S. Pat. No. 6,442,529. Methods and apparatus for delivering targeted information and advertising over the Internet. Aug. 27, 2002.) aimed at lowering the cost of Internet access, which enable ISP switching equipment to provide the advertising content to subscribers during the intervals pending the receipt of information requested by the subscribers from Internet resources. The method is implemented by a system consisting of the ISP switching equipment (ISP commutation switch), to which network subscribers' computers (terminals) are connected via mini-portals, on the one side, and on the other side the confirmation server performing the function of identification of subscribers connected to the network, the advertising content server, the statistic server gathering and analysing the information requested by subscribers, on the basis of which targeted advertising is managed with account taken for a number of criteria, and the Internet resources access server (proxy server). The method consists in the download of the target advertising content by a mini-portal to the subscriber's computer during its connection to the provider's network. During intervals, a special programme displays this content on the subscriber's monitor.

The disadvantages of this method and system include the following:
the subscribers' connection to ISP equipment and Internet resources channel bandwidth is constantly increasing, consequently, the time of intervals is being reduced to sizes not registered by humans, and therefore the demonstration of advertising during pending intervals loses all meaning, the more so that the described method needs time to make sure that an interval in data exchange has actually occurred;
the method implementation requires the use of substandard equipment in the form of a mini-portal and software ensuring the functionality of the mini-portal, its interaction with the user's computer and ISP equipment, software for implementing the display of the downloaded advertising content;
to implement the method and system in the mobile communications network, enjoying increasing demand, either the mobile telephones should be fulfilling the function of a mini-portal enabling the download of advertising content, which means they have to be specialised phones, or the mini-portal functions should be performed by a special programme installed on a mobile computer connected to the provider via a mobile telephone;
to implement the method and system, the provider needs to invest funds in development and production of additional hardware and software, and its installation;
during the connection to a provider subscribers have no freedom of choice of equipment based on price and quality considerations, they can only use specialised technical means ensuring the functionality of the advertising content provision method—not a principal function, which can nevertheless reduce their expenses on the provider's services.

Russia's patent 2259585 MPK 8 G09F 19/00, which is the closest analogue, contains an image modification method, specifically for advertising purposes, with the help of an application on the screen of the user computer system display device. The computer system runs the application on command of the operating system; the method consists of phases of input of an external signal to the user computer system, forming a multimedia animation symbol (ad) in the picture after its input. The multimedia animation symbol is being input in such a way to allow it to appear persistently on the screen at a moment in time or with the size that cannot be identified by the computer user by viewing the picture before the input of this symbol. The persistent method is used by the operating system forming multi-layer window images on the screen, with the symbol being placed in the top layer of the application window in such a way that the user could not move it behind the screen or cover it with other objects. The symbol development is managed by signals stored in the database in response to information exchange from the user's computer.

This method has one thing in common with the proposed solution: the subscriber received the target advertising in a persistent way in response to information exchange.

This method and system has the following disadvantages: to implement the method and system, the provider has to invest in development and production of additional hardware and software, and in its installation.

### SUMMARY OF THE INVENTION

The invention is based on the task of creating an efficient method of formation, transmission and delivery of the target advertising content and any other information by an operator to a specific subscriber and/or certain group of subscribers during the request of Internet resources.

The goal is attained by applying a method of target advertising and other target information delivery by operators consisting in the following: during the connection of the subscriber's terminal to the operator's network he is being authenticated—identified and verified for access authorisation—and granted an access channel with remote databases; simultaneously, a command code page (the operator's webpage) is formed in the operator's server with a sequence of advertising content request command; after receiving an information package from the subscriber containing a remote resource address request command, the subscriber's request command is stored and processed in the operator's server and entered at the end of the advertising content request commands sequence of the command code page (the operator's webpage), and this command code page is sent to the subscriber; after the command code page is downloaded in the subscriber's terminal the advertising content is displayed on the terminal's monitor; during its viewing, the subscriber's information package containing the command of request of the remote resource address is repeatedly initialled and sent to remote databases over the communication channel.

To ensure the necessary time interval for comprehension of the advertising content by the subscriber, a programme timer is switched on after the repeated initiation of the subscriber's request command, upon the expiration of which the information requested by the subscriber and delivered during the timer's operation time is displayed.

The demonstration of the advertising content is terminated after the registration of the subscriber's reaction—pressing the “Clear” button or another button, displayed on the advertising content page.

The timer is stopped after the registration of the subscriber's reaction—pressing the “Select” button displayed on the advertising content page.

The registration of the subscriber's reaction—the pressing of the “Select” button—initiates the download of command code pages demonstrating to the subscriber the advertising content or some other information provided by the advertiser or another source.

The information requested by the subscriber is displayed after the registration of the subscriber's reaction—pressing the “Clear” button or another button, displayed on the advertising content page of the advertiser.

The transmission of the advertising command code page to the subscriber is initiated after detection of the first subscriber's request.

The transmission of the advertising command code page to the subscriber is initiated on condition of detection of the subscriber's request.

The command code page (the operator's webpage) is formed with the sequence of advertising content request commands earlier than a response is received from the requested information Internet resource. If the report from the operator's webpage is received later than the requested information Internet resource, it is ignored.

The sequence of advertising content request commands makes references to information resources both in the operator's local network and in the World Wide Web.

The invention solves the task of creating a system of target advertising or other target information delivery, implementing the requested method and, by means of introducing new elements, enables to simplify the known systems of target advertising or other information delivery by eliminating special substandard technical means.

The set goal is achieved by entering in the system of target advertising delivery by communications operators or Internet providers the subscriber terminals connected by wire or wireless communication channels to Internet service providers' (ISP) switching equipment the first input/output of which is connected to the first input/output of the Internet resources access server (or proxy server), the second input/output of which is connected to Internet resources, the second ISP input/output is connected to the first input/output of the advertising management module for detection and receipt of the information package from the subscriber containing the command of remote Internet resource address request and identification of subscribers on the basis of their parameters in the operator's local network, the first monitoring input of the advertising management module is connected to the first ISP input/output, the second and third input/output of the advertising management module is connected to the statistics server and advertising content server, accordingly, the fourth input/output of the advertising management module is intended for connection to the operator's management terminal, and the second monitoring input of the advertising management module is connected to the third ISP input/output connected, in turn, to the input/output of the confirmation server for performing data exchange operations with the confirmation server containing subscribers' registration data and their parameters in the network.

To identify the users, the advertising management module uses unique parameters (e.g. IP address, IMSI, identification parameters, etc.) of the user and/or the user's equipment (hereinafter—“equipment parameters”) contained in the Internet resource request reports.

To identify the profile of a user the equipment parameters of which were detected for the first time, the advertising management module requests the confirmation server registration data (e.g. RADIUS server) and stores them in the statistics server.

### BRIEF DESCRIPTION OF THE DRAWINGS

FIG. 1 displays the method implementation diagram;

FIG. 2 displays the structural diagram of the target advertising provision system implementing this method.

### DETAILED DESCRIPTION OF THE PREFERRED EMBODIMENTS

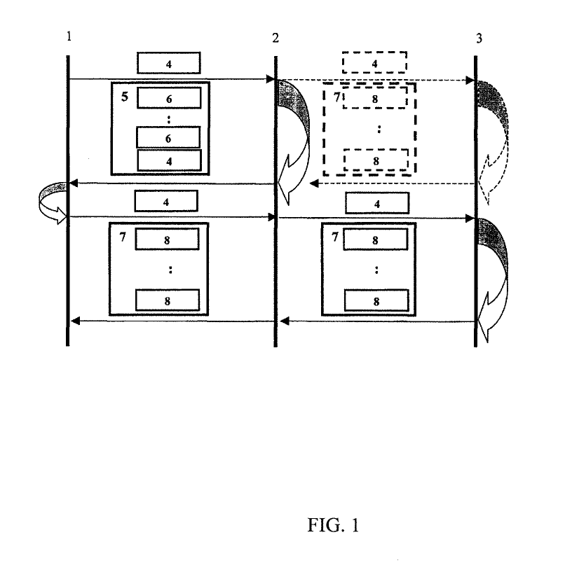

The method in question is implemented in the following manner. FIG. 1 displays the method implementation diagram. Three interacting parties—the subscriber terminal 1, equipment of the operator 2, and the Internet resource 3—are marked with vertical lines. The subscriber 1 requests an Internet resource by sending a package with URL 4, the operator 2 registers the first package and transmits its page 5 in response, containing the information content and sequence of the advertising content requests command 6, as well as the subscriber request 4. The first request 4 may be annulled by the operator, which may also continue movement towards the Internet resource 3, where it will initiate the transmission of the requested page 7 with the information content and request commands sequence 8, but as the operator's page 5 will reach the subscriber as a response to his request 4 earlier, the repeated response in the form of the requested page 7 will be ignored by the subscriber terminal 1. The implementation of the page programme 5 on the subscriber terminal 1 will initiate a repeated transmission of the request 4, which will proceed via the operator's equipment 2 to the Internet resource 3, where it will initiate the transmission of the requested page 7, which will be transferred via the operator's equipment 2 to the subscriber's terminal 1.

It is noteworthy that a webpage usually has an average volume of 300 Kbytes. Data are transmitted in packages (e.g. with the help of the Transport Control Protocol) in the volume not exceeding 1.5 Kbytes, therefore the process of transmission of request commands 4, 6 and 8 and response transmission of pages 5 and 7 with text and other information, containing the following reference commands or not, consists of a total of some 200 transactions. One transaction cancelled by the operator or ignored by the subscriber would not cause a significant additional burden on the network in this sequence of transactions. The Internet resource reference address includes the name of the root catalogue and the path to attachments. The transmission by the operator 2 of the page 5 can be initiated only by references 4 to the root catalogues.

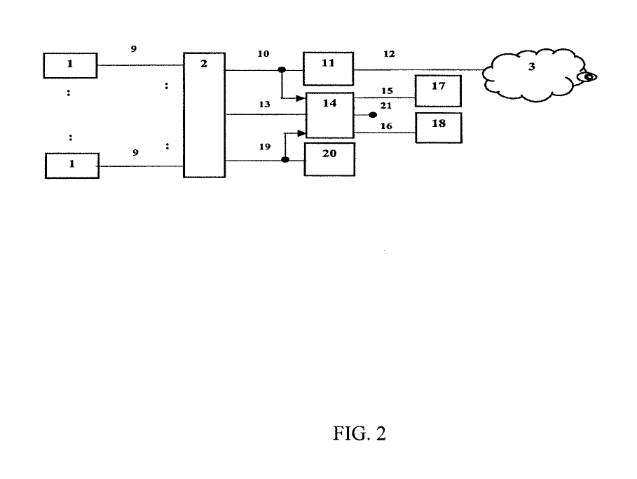

FIG. 2 displays the structural diagram of the target advertising provision system implementing the method in question. The system includes a certain number of subscriber terminals connected by wire or wireless communication channels 9 to ISP switching equipment (commutation switch) 2, the first input/output 10 of which is connected to the first input/output of the Internet resources access service (proxy server) 11, the second input/output 12 of which is connected to Internet resources 3, the second input/output 13 of the commutation switch 2 is connected to the first input/output of the advertising management module 14, the first monitoring input of which is connected to the first input/output 10 of the commutation switch 2, the second 15 and third 16 input/output are connected to the statistics server 17 and advertising content server 18, accordingly, the second monitoring input is connected to the third input/output 19 of the commutation switch 2, which is connected to the input/output of the confirmation server 20, the fourth input/output 21 of the advertising management module 14 is intended for connection of the operator's terminal.

The system operates in the following manner. During the activation of the subscriber terminal 1, the commutation switch performs its identification with the help of the confirmation server 20. The advertising management module 14 also identifies the subscriber by transaction monitoring on the channel 19, defines the subscriber's category on the basis of statistic data stored on the statistics server 17 and forms the advertising content on the operator's webpage 5 by reading advertising materials from the server 18. When the subscriber has received access and transmitted his request 4 to the Internet resource 3, the advertising management module 14 also receives this request by monitoring the communication line 10, transmits the resource address to the statistics server 17, which analyses its thematic category. If the category is identified, the statistics server transmits it to the advertising management module 14 and the management module requests thematic advertising from the server 18 and inserts the request commands in the operator's webpage 5. If the request category is not identified, the management module inserts “default” request commands. The statistics server 17 calculates the number of requests 4 of the subscriber and classifies his requests in accordance with the thematic criteria. It also registers the demonstration of advertising. The management module 14 inserts in the operator's webpage 5 the subscriber's request command 4 and sends the operator's page via the communication line 13 to the subscriber terminal 1, indicating its address and transaction parameters, which is used for transmission of the request 4 in such a way that it would be received by the terminal 1 as a response to the request 4. After the display of the first two parts of the advertising content of the page 5 on condition that the subscriber does not follow the advertising reference by pressing the “Select” button, the programme on the subscriber terminal 1 will resume the request 4 on the timer's signal or the subscriber's click on the “Clear” button, the request 4 will be repeatedly transmitted to the Internet resource. If the subscriber shows interest in the advertising content by clicking the “Select” button, the programme will resume the request 4 after the advertising content is viewed and the subscriber returns to the initial programme displaying the operator's webpage 5. The management module 14 reads the advertising content of the webpage 5 from the advertising server 18 and places it in the memory section allocated for each subscriber's advertising session, thus ensuring prompt completion of requests 6. When the subscriber has demonstrated interest in advertising, the access to its resources will be registered by the management module during the transmission of requests 6 via the communication line 6 or access to the subscriber's advertising session memory. The management module 14 transmits the information on the transfer of requests 6 to the statistics server 17 for registration of the number of successful target advertising sessions.

The operator may use the port 21 of the management module 14 for the input of the advertising content, telematic advertising categories, analysis of statistics of requests and successful advertising sessions.

The advertising transmission method and the system operation do not require additional technical means—specialised portals or software. They use only standard and publicly available technical means. The advertising management module is a computer with unified interfaces for communication with the commutation switch and servers (e.g. Ethernet); its monitoring inputs are also unified interfaces operating in the receive-only mode. Therefore the method and system can be implemented on the basis of any operating system and any web-browser installed by the subscriber on the subscriber's equipment and terminal (computer, mobile telephone). The system's connection to the operator's equipment does not require additional software, only a unified local network access port and two traffic monitoring ports to the proxy server and the confirmation server, e.g. DNS server or Radius server.

1. A method of target advertising or information delivery by communication operators or Internet providers comprising: during a subscriber's connection from a terminal to a network of the operator, the subscriber is being authenticated and granted an access channel with remote databases; simultaneously, a command code page is formed in a server of the operator with a sequence of advertising content request command; after receiving an information package from the subscriber containing a remote resource address request command, the subscriber's request command is stored and processed in the operator's server and entered at the end of the advertising content request commands sequence of the command code page, and this command code page is sent to the subscriber; after the command code page is downloaded in the subscriber's terminal the advertising content is displayed on a monitor of the terminal; during viewing, the subscriber's information package containing the command of request of the remote resource address is repeatedly initialled and sent to remote databases over the communication channel.

2. The method of claim 1, where the ensuring of an interval necessary for the comprehension of advertising content and/or information by a subscriber, a programme time is switched on after repeated initiation of the subscriber's request command, upon the expiration of which the information requested by the subscriber and delivered during the timer operation period is displayed.

3. The method of claim 1, where the demonstration of the advertising content is terminated after the registration of the subscriber's reaction—pressing the “Clear” button or another button displayed on the advertising content page.

4. The method of claim 2, where the operation of the timer is terminated after the registration of the subscriber's reaction—pressing the “Select” button displayed on the advertising content page.

5. The method of claim 4, where the download of the advertiser's command code page is initiated for demonstrating to the subscriber the advertising content or other information provided by the advertiser after the registration of the subscriber's reaction—pressing the “Select” button.

6. The method of claim 5, where the information requested by the subscriber is displayed after the subscriber's reaction—pressing the “Clear” button displayed on the advertiser's advertising content page.

7. The method of claim 1, where the command code page transmission to the subscriber is initiated after detecting the first request of the subscriber.

8. The method of claim 1, where the command code page transmission to the subscriber is initiated on condition of detection of the subscriber's request.

9. The method of claim 1, where the command code page (the operator's webpage) is formed with the sequence of the advertising content request commands earlier than a similar response will arrive from the requested information Internet resource, and if the report with the operator's webpage arrives later than the requested information Internet resource, it will be ignored.

10. The method of claim 1, where the sequence of the advertising content request commands makes references to information resources both in the operator's local network and in the World Wide Web.

11. A system of target advertising delivery by communications operators or Internet providers containing subscriber terminals connected by wire or wireless communication channels to Internet service providers' (ISP) switching equipment having a first input/output connected to a first input/output of an Internet resources access server and a second input/output connected to Internet resources, a second ISP input/output being connected to a first input/output of an advertising management module for detection and receipt of an information package from the subscriber containing a command of remote Internet resource address request and identification of subscribers on the basis of their parameters in the operator's local network of the operator, the first monitoring input of the advertising management module being connected to a first ISP input/output, second and third input/outputs of the advertising management module being connected to a statistics server and an advertising content server, a fourth input/output of the advertising management module being connectable to a management terminal of the operator, and a second monitoring input of the advertising management module being connected to a third ISP input/output, which is connected to an input/output of the confirmation server for performing data exchange operations with the confirmation server containing subscribers' registration data and their parameters in the network.

12. The system claim 11, where the advertising management module uses individual parameters of the user selected from the group consisting of IP address, IMSI, identification parameters of the user's equipment present in the Internet resource request responses.

13. The system of claim 11, where the advertising management module requests the confirmation server registration data to identify the profile of the user the equipment parameters of which were detected for the first time, and stores them in the statistics server.
